(19) United States
(12) Patent Application Publication
(10) Pub. No.: US 2007/0188635 A1
(43) Pub. Date: Aug. 16, 2007

(54) Solid-state imaging device and camera

(76) Inventors: Takumi Yamaguchi, Kyoto (JP); Yuichi Inaba, Osaka (JP); Daisuke Ueda, Osaka (JP)

Correspondence Address: MCDERMOTT WILL & EMERY LLP, 600 13TH STREET, N.W., WASHINGTON, DC, 20005-3096, US

(21) Appl. No.: 11/633,583

(22) Filed: Dec. 5, 2006

(30) Foreign Application Priority Data
Feb. 15, 2006 (JP) 2006-038598

(51) Int. Cl. H04N 9/04

(52) U.S. Cl. 348/272

(57) ABSTRACT

A solid-state imaging device 101 is composed of a transparent film 204, a color filter 205, a planarizing film 207, and a plurality of microlenses 208 that are sequentially formed on a semiconductor substrate 201. A photodiode 202 is formed in a surface of the semiconductor substrate 201 that is closer to the transparent film 204. A light shielding film 203 is formed in a surface of the transparent film 204 that is closer to the semiconductor substrate 201. Color filters 205 respectively corresponding to two adjacent pixels are partitioned by a light shielding wall 206. The light shielding wall 206 is a λ/4 multilayer film that reflects visible light.

### CROSS-REFERENCE TO RELATED APPLICATIONS

This application is based on application No. 2006-038598 filed in Japan, the contents of which are hereby incorporated by reference.

### BACKGROUND OF THE INVENTION

(1) Field of the Invention

The present invention relates to a solid-state imaging device and a camera, and particularly to a light shielding technique for preventing light that transmits a color filter from entering an unintended photoelectric device.

(2) Related Art

Solid-state imaging devices that have spread widely in recent years image in color by detecting light intensity of each color using color filters.

FIG. 1 is a block diagram showing a structure of a solid-state imaging device according to a conventional art. As shown in FIG. 1, a solid-state imaging device 5 includes a plurality of pixels 501, a vertical shift register 502, a vertical signal line 503, a column memory 504, a horizontal shift register 505, a horizontal signal line 506, and an output amplifier 507.

The pixels 501 are two-dimensionally arrayed. Any of color filters of red (R), green (G1 and G2), and blue (B) is allocated to each pixel 501 in accordance with a Bayer pattern.

Pixel signals generated by the pixels 501 are selected by the vertical shift register 502 for each column, and are transferred to the column memory 504 via the vertical signal line 503. Then, the pixel signals sequentially selected by the horizontal shift register 505 are transmitted to the horizontal signal line 506, and are output via the output amplifier 507.

FIG. 2 is a sectional view showing a structure of the pixels 501 (See Japanese Patent Application Publication No. 2005-294647, for example). As shown in FIG. 2, the solid-state imaging device 5 is composed by sequentially forming a transparent film 604, a plurality of color filters 605, a planarizing film 607, and a microlens 608 on a semiconductor substrate 601.

Moreover, a photodiode 602 is formed in a surface of the semiconductor substrate 601 that is closer to the transparent film 604. A light shielding film 603 is formed in a surface of the transparent film 604 that is closer to the semiconductor substrate 601. Also, the color filters 605 respectively corresponding to two adjacent pixels 501 are partitioned by a light shielding wall 606 made from a resin material.

With this structure, light that penetrates one of the color filters 605 does not enter a photodiode 602 of a pixel 501 not corresponding to the color filter 605. Accordingly, color mixing due to oblique light can be prevented.

However, there is a great demand for miniaturization and increase of the number of pixels in solid-state imaging devices. On the other hand, it is difficult to thin a breadth of the light shielding wall 606 made from the resin material that partitions the color filters for each pixel. Accordingly, in order to reduce a pixel size to 3 μm or less, each color filter 605 needs to have a smaller dimension. As a result, quantity of incident light to the photodiode 602 decreases, and this causes sensitivity deterioration.

### SUMMARY OF THE INVENTION

The present invention is made to solve the above-described problem. An object of the present invention is to provide a solid-state imaging device and a camera that are miniature, have a large amount of pixels, and can prevent color mixing due to oblique light.

In order to achieve the above object, the present invention is a solid-state imaging device that includes two-dimensionally arrayed pixels and images in color, the solid-state imaging device comprising: a plurality of color filters each operable to transmit light of a wavelength predetermined for each pixel; and a light shielding wall operable to partition the color filters for each pixel, wherein the light shielding wall includes a multilayer film and reflects visible light, the multilayer film being composed of alternately laminated two types of dielectric layers each having a different refractive index and a same optical thickness.

With the above structure, the light shielding wall that prevents color mixing due to oblique light can be miniaturized in comparison with the case where a light shielding wall is made from a resin material. Therefore, since this can prevent deterioration of sensitivity caused by miniaturization of pixels, a miniature solid-state imaging device having a large amount of pixels can be provided.

A solid-state imaging device according to the present invention is a solid-state imaging device in which each of the color filters is a multilayer interference filter. With the above structure, each color filter and the light shielding wall can be formed together through a semiconductor process. As a result, the manufacturing process can be simplified, and therefore manufacturing costs can be reduced.

In this case, it is further preferable that the light shielding wall and at least one of the color filters have a same number of layers.

A solid-state imaging device according to the present invention is a solid-state imaging device in which the light shielding wall and the color filters are made from a same dielectric material. With the above structure, the number of types of materials needed for manufacturing solid-state imaging devices can be reduced, and accordingly manufacturing costs can be reduced.

A solid-state imaging device according to the present invention is a solid-state imaging device in which the multilayer interference filters that constitute the color filters are composed of two λ/4 multilayer films with a spacer layer sandwiched therebetween, and each dielectric layer that constitutes the light shielding wall and each dielectric layer of the λ/4 multilayer films that constitute the color filters have a same optical thickness. With the above structure, each dielectric layer that constitutes the light shielding wall and each dielectric layer of the λ/4 multilayer films that constitutes the color filter can be formed thorough the same semiconductor process. Accordingly, manufacturing costs can be reduced.

Also, the light shielding wall may be a multilayer interference filter composed of two λ/4 multilayer films with a spacer layer sandwiched therebetween. Also, a multilayer interference filter that constitutes each color filter may be composed of two λ/4 multilayer films with a spacer layer sandwiched therebetween, and a film thickness of the spacer layer may differ according to a color of light transmitted by the color filter. Furthermore, the light shielding wall may be composed of two λ/4 multilayer films with a spacer layer sandwiched therebetween, and the spacer layer of the color filter may have an optical thickness different from an optical thickness of the spacer layer of the light shielding wall.

A camera according to the present invention is a camera having a solid-state imaging device, the solid-state imaging device comprising: two-dimensionally arrayed pixels; a plurality of color filters each operable to transmit light of a wavelength predetermined for each pixel; and a light shielding wall operable to partition the color filters for each pixel, wherein the light shielding wall includes a multilayer film and reflects visible light, the multilayer film being composed of alternately laminated two types of dielectric layers each having a different refractive index and a same optical thickness. With the above structure, a camera that realizes color imaging with high image quality can be achieved.

### BRIEF DESCRIPTION OF THE DRAWINGS

These and other objects, advantages and features of the invention will become apparent from the following description thereof taken in conjunction with the accompanying drawings those illustrate a specific embodiments of the invention.

In the drawings:

FIG. 1 is a block diagram showing a structure of a solid-state imaging device according to a conventional art;

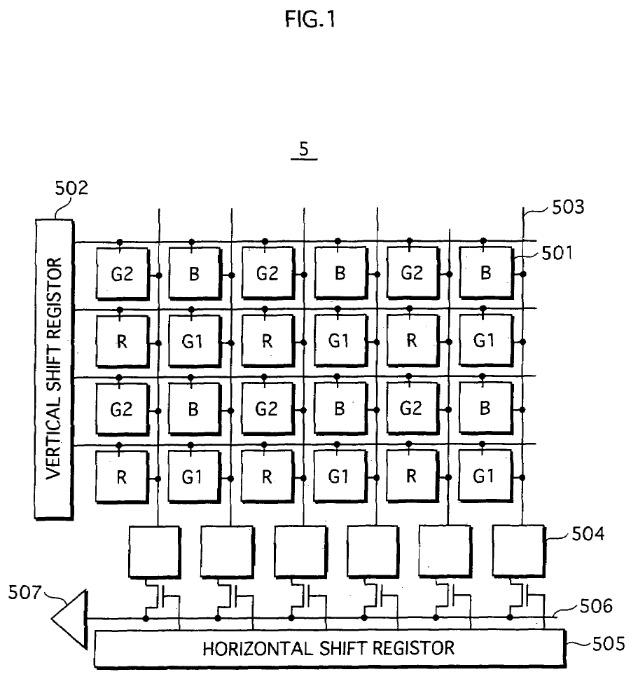

FIG. 2 is a sectional view showing a structure of pixels 501 of the solid-state imaging device according to the conventional art;

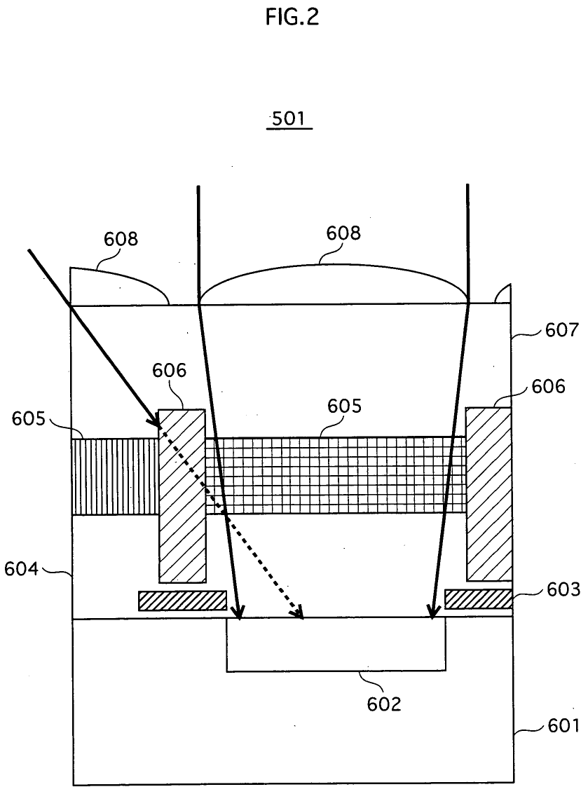

FIG. 3 is a sectional view showing a structure of a digital camera according to an embodiment;

FIG. 4 is a sectional view showing a pixel of a solid-state imaging device 101;

FIG. 5A shows a structure of one of the color filters 205 that transmits blue light (hereinafter “blue filter”), FIG. 5B shows a structure of one of the color filters 205 that transmits red light (hereinafter “red filter”), FIG. 5C shows a structure of one of the color filters 205 that transmits green light (hereinafter “green filter”), and FIG. 5D shows a structure of the light shielding wall 206; and

FIG. 6A to FIG. 6D show spectral characteristics of the red filter, the green filter, the blue filter, and the light shielding wall 206, respectively.

### DESCRIPTION OF PREFERRED EMBODIMENT

The following describes an embodiment of a solid-state imaging device and a camera according to the present invention using a digital camera as an example, with reference to the drawings.

### [1] Structure of Digital Camera

First, a structure of a digital camera according to an embodiment is described.

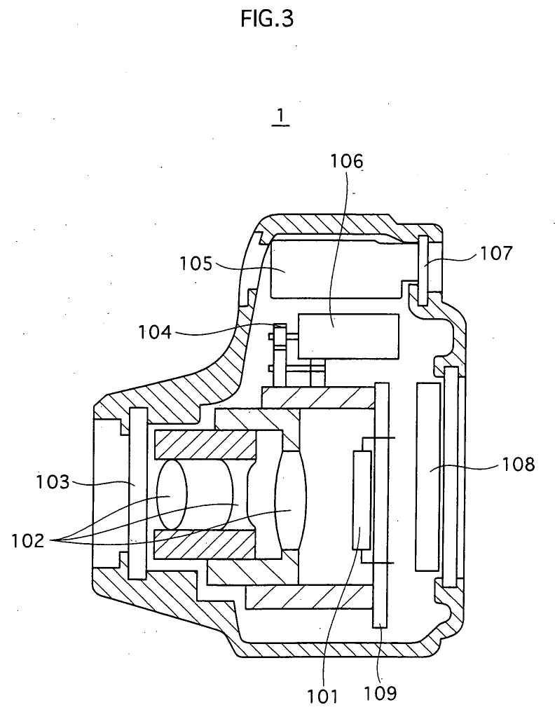

FIG. 3 is a sectional view showing a structure of the digital camera according to the embodiment. As shown in FIG. 3, a digital camera 1 includes a solid-state imaging device 101, an imaging lens 102, a cover glass 103, a gear 104, an optical finder 105, a zoom motor 106, a finder eyepiece 107, an LCD (liquid crystal display) monitor 108, and a circuit board 109.

A user of the digital camera 1 observes a subject by looking through the optical finder 105 through the finder eyepiece 107 to select a camera angle. Also, the user operates the zoom motor 106 to adjust a zoom of the imaging lens 102 via the gear 104.

Light from the subject transmits the cover glass 103 and the imaging lens 102, and then enters the solid-state imaging device 101. An imaging signal acquired in the solid-state imaging device 101 is processed in the circuit board 109, and is displayed on the LCD monitor 108. Also, on the LCD monitor 108, imaging modes etc. are displayed.

The cover glass 103 protects the imaging lens 102, and also achieves a waterproofing function.

### [2] Structure of Solid-State Imaging Device 101

Next, a structure of the solid-state imaging device 101 is described. Although the solid-state imaging device 101 has the substantially same structure as that of solid-state imaging devices according to conventional arts, the solid-state imaging device 101 has a different structure of a light shielding wall from that of the solid-state imaging devices according to the conventional arts.

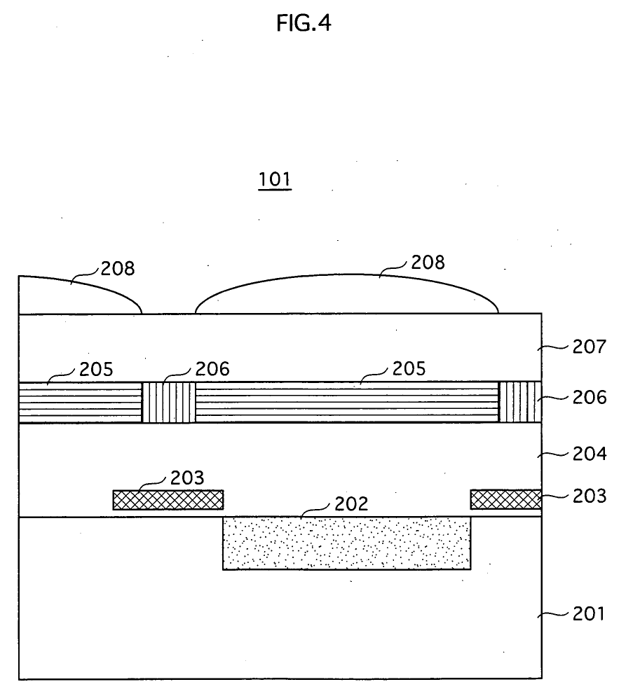

FIG. 4 is a sectional view showing a pixel of the solid-state imaging device 101. As shown in FIG. 4, the solid-state imaging device 101 is composed of a transparent film 204, a plurality of color filters 205, a planarizing film 207, and a plurality of microlenses 208 that are sequentially formed on a semiconductor substrate 201, in the same way as the solid-state imaging device 5 according to the conventional art.

Furthermore, a photodiode 202 is formed in a surface of the semiconductor substrate 201 that is closer to the transparent film 204. A light shielding film 203 is formed in a surface of the transparent film 204 that is closer to the semiconductor substrate 201. Also, color filters 205 respectively corresponding to two adjacent pixels are partitioned by the light shielding wall 206.

### [3] Structures of Color Filters 205 and Light Shielding Wall 206

Next, structures of the color filters 205 and the light shielding wall 206 are described.

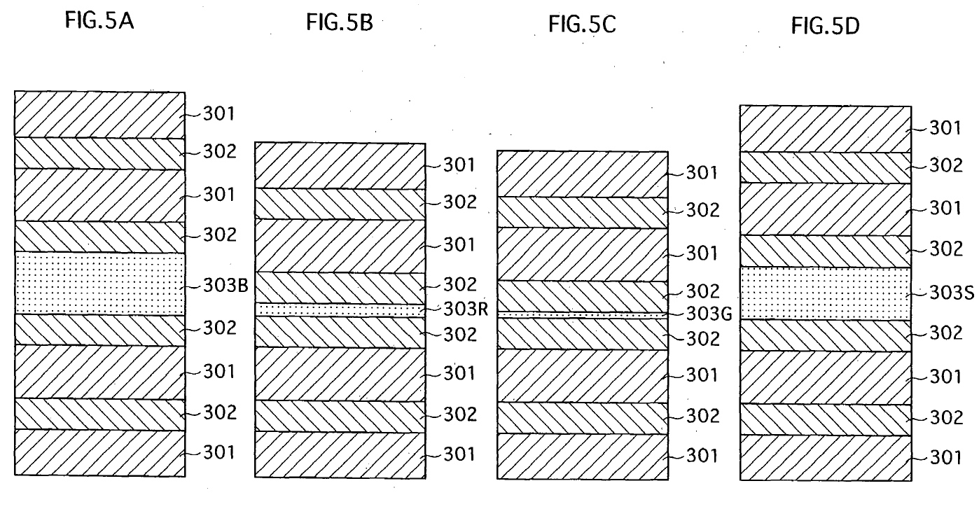

FIG. 5A shows a structure of one of the color filters 205 that transmits blue light (hereinafter “blue filter”), FIG. 5B shows a structure of one of the color filters 205 that transmits red light (hereinafter “red filter”), FIG. 5C shows a structure of one of the color filters 205 that transmits green light (hereinafter “green filter”), and FIG. 5D shows a structure of the light shielding wall 206.

As shown in FIG. 5A to FIG. 5D, the color filters 205 and the light shielding wall 206 each has a nine-layer structure, which is made from two kinds of dielectric materials of silicon dioxide (SiO₂) and titanium dioxide (TiO₂). Silicon dioxide layers 301 and 303S, and a titanium dioxide layer 302 have the same optical thickness. On the other hand, silicon dioxide layers 303R, 303G, and 303B have a thickness different from each other, and also have a thickness different from that of the silicon dioxide layer 301.

That is to say, each color filter 205 is a multilayer interference filter having, as a spacer layer, the silicon dioxide layers 303R, 303G, and 303B, for red light, green light, and blue light, respectively. On the other hand, the light shielding wall 206 is a λ/4 multilayer film having four times an optical thickness of each dielectric layer as a set wavelength.

Here, an optical thickness of a dielectric layer is a value obtained by multiplying a physical thickness of the dielectric layer by a refractive index of a material of the dielectric layer. Also, the λ/4 multilayer film is composed of two types of dielectric layers each having the same optical thickness and a different refractive index. And, the λ/4 multilayer film reflects light of a wavelength in a wavelength range having four times the optical thickness as a center wavelength. This center wavelength is called a set wavelength λ.

In the embodiment, a set wavelength λ is 550 nm, which is the substantially center wavelength in a visible wavelength range. Each of the silicon dioxide layers 301 and 303S, and the titanium dioxide layer 302 has an optical thickness of 137.55 nm, which is one fourth of the set wavelength λ 550 nm. Since silicon oxide has a refractive index of 1.45, each of the silicon dioxide layers 301 and 303S has an optical thickness of 94.8 nm. Also, since titanium dioxide has a refractive index of 2.51, the titanium dioxide layer 302 has an optical thickness of 54.7 nm.

Also, the silicon dioxide layers 303R and 303G, and the silicon dioxide layer 303B have optical thicknesses of 20 to 40 nm, 0 to 10 nm, and of 120 to 140 nm, respectively, which are different from that of the silicon dioxide layer 301.

In this way, the light shielding wall 206 can be formed together with the color filters 205. Therefore, a solid-state imaging device that can prevent oblique light can be manufactured at lower costs.

### [4] Spectral Characteristics

With the above-described structure, each color filter 205 performs spectral deconvolution on incident light, and the light shielding wall 206 reflects visible light.

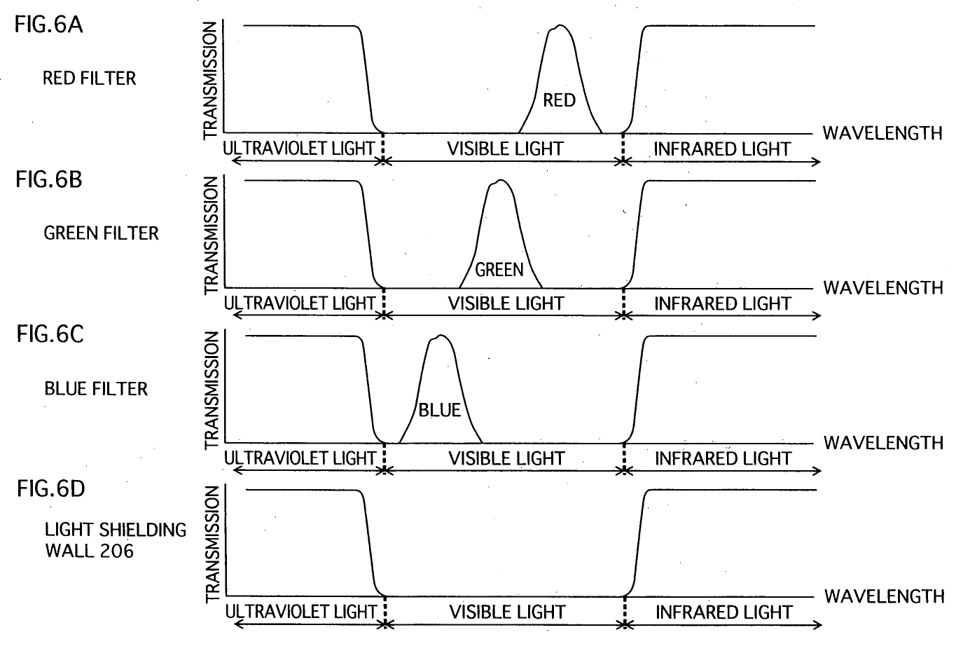

FIGS. 6A, 6B, and 6C show spectral characteristics of the red filter, the green filter, and the blue filter, respectively. Also, FIG. 6D shows spectral characteristics of the light shielding wall 206.

As shown in FIG. 6A to FIG. 6C, the red filter, the green filter, and the blue filter transmit red light, green light, and blue light in the visible wavelength range respectively, and also transmit ultraviolet light and infrared light. On the other hand, the light shielding wall 206 transmits ultraviolet light and infrared light, however, reflects all visible lights.

That is to say, since the light shielding wall 206 mainly reflects a visible component-included in oblique light, color mixing can be prevented. Also, the light shielding wall 206 can be miniaturized in comparison with light shielding walls made from resin materials. This can prevent deterioration of sensitivity caused by miniaturization of solid-state imaging devices.

### [5] Modifications

Although the present invention has been described based on the above embodiment, the present invention is not of course limited to the embodiment, and further includes the following modifications.
(1) In the above embodiment, the case has been described where the multilayer interference filter is used as the color filters 205. However, the present invention is not of course limited to the embodiment, other color filters may be used instead of the multilayer interference filter. Regardless of type of color filters, if adopting a λ/4 multilayer film for a light shielding wall, the light shielding wall can be miniaturized in comparison with light shielding walls made from resin materials. This can prevent deterioration of sensitivity caused by miniaturization of solid-state imaging devices.

Also, light shielding walls made from λ/4 multilayer films can be easily formed through semiconductor process. Accordingly, manufacturing costs can be reduced.
(2) In the above embodiment, the case has been described where the color filters that perform spectral deconvolution on red light, green light, and blue light is partitioned by the light shielding wall. However, the present invention is not of course limited to this. Instead, other color filters may be partitioned. For example, color filters that each performs spectral deconvolution on lights of four colors of cyan (Cy), magenta (Mg), yellow (Ye), and green (G) may be partitioned by the light shielding wall. Regardless of color of light on which spectral deconvolution is performed by the color filters, the effects of the present invention can be achieved.
(3) In the above embodiment, the case has been described where the light shielding wall is composed of nine dielectric layers. However, the present invention is not of course limited to this.

However, too few layers cause incident light to easily transmit the light shielding wall. Also, too many layers cause manufacturing costs to rise. Therefore, it is desirable that light shielding films have the number of layers so as to achieve light shielding performance commensurate with manufacturing costs.
(4) In the above embodiment, the case has been described where the light shielding film and each color filter have the same number of layers. However, the present invention is not of course limited to this. The light shielding film and the color filter may not have the same number of layers. Note that, if adopting a color filter composed of the same number of dielectric layers as that of a light shielding film, manufacturing costs can be reduced particularly.
(5) In the above embodiment, the case has been described where silicon dioxide and titanium dioxide are used as materials of the light shielding material. However, the present invention is not of course limited to this. Instead, the following may be used: magnesium oxide (MgO), ditantalum trioxide (Ta₂O₅), zirconium dioxide (ZrO₂) silicon nitride (SiN), trisilicon tetranitride (Si₃N₄), dialuminum trioxide (Al₂O₃), magnesium difluoride (MgF₂), and hafnium trioxide (HfO₃).

Particularly, ditantalum trioxide, zirconium dioxide, and trisilicon tetranitride are preferably used as high refractive index materials. Regardless of type of materials of dielectric layers, the effects of the present invention can be achieved.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A solid-state imaging device that includes two-dimensionally arrayed pixels and images in color, the solid-state imaging device comprising:
a plurality of color filters each operable to transmit light of a wavelength predetermined for each pixel; and
a light shielding wall operable to partition the color filters for each pixel, wherein
the light shielding wall includes a multilayer film and reflects visible light, the multilayer film being composed of alternately laminated two types of dielectric layers each having a different refractive index and a same optical thickness.

2. The solid-state imaging device of claim 1, wherein
each of the color filters is a multilayer interference filter.

3. The solid-state imaging device of claim 2, wherein
the light shielding wall and at least one of the color filters have a same number of layers.

4. The solid-state imaging device of claim 2, wherein
the light shielding wall and the color filters are made from a same dielectric material.

5. The solid-state imaging device of claim 4, wherein
the multilayer interference filters that constitute the color filters are composed of two λ/4 multilayer films with a spacer layer sandwiched therebetween, and
each dielectric layer that constitutes the light shielding wall and each dielectric layer of the λ/4 multilayer films that constitute the color filters have a same optical thickness.

6. The solid-state imaging device of claim 1, wherein
the light shielding wall is a multilayer interference filter composed of two λ/4 multilayer films with a spacer layer sandwiched therebetween.

7. The solid-state imaging device of claim 1, wherein
a multilayer interference filter that constitutes each color filter is composed of two λ/4 multilayer films with a spacer layer sandwiched therebetween, and
a film thickness of the spacer layer differs according to a color of light transmitted by the color filter.

8. The solid-state imaging device of claim 7, wherein
the light shielding wall is composed of two λ/4 multilayer films with a spacer layer sandwiched therebetween, and
the spacer layer of the color filter has an optical thickness different from an optical thickness of the spacer layer of the light shielding wall.

9. A camera having a solid-state imaging device, the solid-state imaging device comprising:
two-dimensionally arrayed pixels;
a plurality of color filters each operable to transmit light of a wavelength predetermined for each pixel; and
a light shielding wall operable to partition the color filters for each pixel, wherein
the light shielding wall includes a multilayer film and reflects visible light, the multilayer film being composed of alternately laminated two types of dielectric layers each having a different refractive index and a same optical thickness.
